(19) United States
(12) Patent Application Publication
(10) Pub. No.: US 2015/0250569 A1
(43) Pub. Date: Sep. 10, 2015

(54) SUPERSTRUCTURE AND METHODS FOR MANUFACTURING THE SAME

(71) Applicant: HERAEUS DENTAL AB, Helsingborg (SE)

(72) Inventors: Kristofer Frick, Angelholm (SE); Fredrik Jonsson, Angelholm (SE)

(73) Assignee: HERAEUS DENTAL AB, Helsingborg (SE)

(21) Appl. No.: 14/433,969

(22) PCT Filed: Jun. 26, 2013
(86) PCT No.: PCT/EP2013/063425

§ 371 Date: Apr. 7, 2015

(30) Foreign Application Priority Data
Oct. 11, 2012 (SE) 1251151-5

(51) Int. Cl. A61C 13/08; A61C 13/00

(52) U.S. Cl. CPC A61C 13/08; A61C 13/0006

(57) ABSTRACT

A dental superstructure (10) for attachment to dental abutments (20) and/or a dental implants (200) is provided. The dental superstructure (10) comprises a main body (11) and a plurality of connecting parts (12) for connection to the dental abutments (20) and/or dental implants (200), said main body (11) connecting said connecting parts (12). The connecting parts (12) comprise a female member (13) for receiving a male member (23) of a dental abutment (20) or a dental implant (200), wherein said female member (13) is of a compliant material.

### TECHNICAL FIELD

The present invention pertains to a dental superstructure attaching system for use with a dental implant to enable removable attachment of the superstructure and/or a dental prosthesis optionally comprising such a superstructure. More specifically the present invention pertains to a dental superstructure, an abutment for distal cooperation with the dental superstructure and proximal cooperation with a dental implant, for enabling such removable attachment.

### BACKGROUND

The goal of a dental implant system is to restore the patient to normal function, comfort, aesthetic, speech and health regardless of the current oral condition. These implant systems are based on the implantation of dental implants, such as dental implants made of biocompatible titanium, through insertion into the patient's jawbone. In this respect, the use of biocompatible titanium started in Sweden as early as 1950, and has since then been further developed and spread world-wide. During the 1980' s a number of implant systems entered the world market.

It is known in the prior art to make dental prostheses which are removably attachable so as to facilitate cleaning or repair of the prostheses, and to permit ready access to the underlying abutments and gingivae for hygienic purposes and therapeutic aid.

One known method of detachably securing a dental prosthesis makes use of copings fitted onto underlying abutment teeth. The coping is a primary casting having tapered axial outer surfaces which telescopically fits into a retainer socket formed in the underside of the removable prosthesis. The retainer sockets closely conform in shape to the copings and keep the prosthetic appliance seated on the copings during mastication. However, the retentive force is a function of the frictional engagement between the axial coping surfaces and the mating retainer surfaces. The frictional engagement in turn is dependent on the angle of taper of the axial coping surfaces. The greater the angle of taper, the lesser the frictional stress between the telescoping surfaces. Conversely, greater frictional retention can be gained by decreasing the angle of taper. As the taper of the axial coping surface approaches zero, i.e. the coping surfaces become parallel and tubular, the retentive force becomes such that the force of removal of the retainer may exceed the bonding strength of the adhesive used to affix the coping to the underlying abutment tooth, with the result that the coping is pulled off the abutment or the tooth fractures in the attempted removal of the prosthesis.

A known approach to the removable mounting of dental prosthesis, such as the one disclosed in U.S. Pat. No. 4,204,321, consists of installing a dental post in the root of two or more spaced apart teeth, or in dental implants osseointegrated in the jawbone of the patient. In the post is formed a circumferential groove into which is fitted an elastomeric O-ring. The superstructure, i.e. the framework that is to be applied onto abutments or implants, which together with the facing material constitutes the dental prosthesis, to be secured has a recess configured for receiving the post and also has a peripheral groove in the post receiving recess shaped and sized to closely fit over the O-ring in an interference fit which retains the denture to the post. The O-ring also serves to partially relieve stresses imposed upon the post by the denture during mastication. However, since the superstructure and the post are made of metal, the manufacturing of the post and the superstructure need to be very precise in relation to each other, and the use of the O-ring makes the system unnecessarily difficult to clean, since the O-ring needs to be removed from the post for efficient cleaning

### SUMMARY OF THE INVENTION

Accordingly, the present invention preferably seeks to mitigate, alleviate or eliminate one or more of the above-identified deficiencies in the art and disadvantages singly or in any combination and solves at least the above mentioned problems by providing a dental superstructure for attachment to dental abutments and/or a dental implants, said dental superstructure comprising a main body and a plurality of connecting parts for connection to said dental abutments and/or dental implants, said main body connecting said connecting parts, said connecting parts comprising a female member for receiving a male member of a dental abutment or a dental implant, wherein said female member is of a compliant material; and a dental superstructure attaching system for attachment of a dental superstructure to at least one implant, said dental superstructure attaching system comprising: a dental abutment comprising a proximal implant connecting part and a distal dental superstructure connecting part; a dental superstructure comprising a main body and at least one connecting part for connection to said dental abutment; wherein one or both of the distal dental superstructure connecting part and the connecting part of the dental superstructure are of a compliant material, such that said dental superstructure may be removably attached to said dental abutment through a snap fit connection between said distal dental superstructure connecting part and said connecting part of the dental superstructure.

For the same purpose a method for manufacturing of a dental superstructure is provided, said method comprising: obtaining stereo-data in respect of a dental situation of a patient with at least two osseointegrated dental implant, applying information regarding a male member of a dental abutment, digitally or physically attached to said dental implant or being a monolithical part of said dental implant; shaping said dental superstructure, such that said dental superstructure comprises a main body and at least two connecting parts for connection to said dental abutment and/or dental implant, said main body connecting said connecting parts, and said connecting parts comprising a female member for receiving said male member of the dental abutment or the dental implant, wherein said female member is shaped of a compliant material.

Further advantageous features of the invention are defined in the dependent claims.

### BRIEF DESCRIPTION OF THE DRAWINGS

These and other aspects, features and advantages of which the invention is capable of will be apparent and elucidated from the following description of embodiments of the present invention, reference being made to the accompanying drawings, in which

FIG. 1a is a schematic side/cross sectional view of one embodiment of the present invention;

FIG. 1b is a schematic side/cross sectional view of one embodiment of the present invention;

FIG. 2a is a schematic side/cross sectional view of one embodiment of the present invention; and

FIG. 2b is a schematic side/cross sectional view of one embodiment of the present invention.

### DESCRIPTION OF EMBODIMENTS

Several embodiments of the present invention will be described in more detail below with reference to the accompanying drawings in order for those skilled in the art to be able to carry out the invention. The invention may, however, be embodied in many different forms and should not be construed as limited to the embodiments set forth herein. Rather, these embodiments are provided so that this disclosure will be thorough and complete, and will fully convey the scope of the invention to those skilled in the art. The embodiments do not limit the invention, but the invention is only limited by the appended patent claims. Furthermore, the terminology used in the detailed description of the particular embodiments illustrated in the accompanying drawings is not intended to be limiting of the invention.

In general, the present invention pertains to a dental superstructure attaching system 100 for use with a dental implant 200. The dental superstructure attaching system 100 comprises a dental superstructure 10 and a dental abutment 20. The dental superstructure attaching system 100 allows for removable attachment of the dental superstructure 10 to the dental abutment 20, and thus in turn to the dental implant 200.

The dental abutment 20 is attachable at its proximal end zone 21 to the dental implant 200. At its distal end zone 22 the dental abutment 20 is connectable to the dental superstructure 10. The proximal end zone 21 of the dental abutment 20 is provided with a threaded stem 23, which for this reason fits into the threaded cavity 201 in the dental implant 200. The distal end zone 22 is provided with a male member 23, which is connectable to the dental superstructure 10 at the proximal part thereof. The male member 23 comprises a spherical head. When the male member 23 is a spherical head, the dental abutment 20 may be snap fitted into the superstructure 10, and also take up differences in angle between the dental implant 200 and the intended position of the dental superstructure 100, which will be further described below. The dental abutment 20 may be provided with a screw driver receiving means (not shown) at its distal end, to allow for screw retention of the dental abutment 20 into the dental implant 200.

The dental superstructure 10 is a framework that fits and is attachable to dental abutments and/or directly on dental implants, and upon which facing material (not shown), resembling natural teeth, may be provided to the surface thereof, to constitute a dental prosthesis. The dental superstructure 10 thus provides retention for a dental prosthesis.

The dental superstructure 10 comprises a main body 11. The main body 11 connects/bridges a plurality of abutment/implant connecting parts 12. Each abutment/implant connecting part 12 comprises a female receiving member 13. The female receiving member 13 is adapted in size and shape after the male member 23 of the abutment 20, such that the male member 23 may cooperate with the female member 13, to obtain retention of the superstructure 10 on the abutment 20. Thus, when the male member 23 comprises a spherical head, the female member 13 in turn comprises a spherical cavity of the same dimensions as the spherical head of the male member 23. To be able to insert the male member 23 into the female member 13 in a retentive cooperation, at least one of the female member 13 and the male member 23 needs to be of a compliant material. Such compliant material may for example be a thermoplastic material, such as an acrylate polymer or acetal polymer, such as a material selected from the group comprising poly(methyl methacrylate) (PMMA) and polyoxymethylene (POM). To obtain a good and firm retention one of the female member 13 and the male member 23 is of a compliant material while the other one is of a rigid material. Such a rigid material may be a material selected from the group comprising titanium, cobalt, chrome, cobalt-chrome, and other metallic materials frequently used in the dental industry. When the male member 23, which is intended to be positioned relatively constant in the mouth of the patient, is of such rigid material it will be easy to keep the hygiene in the oral cavity, since these kind of rigid materials are easy to clean due to their smooth surfaces.

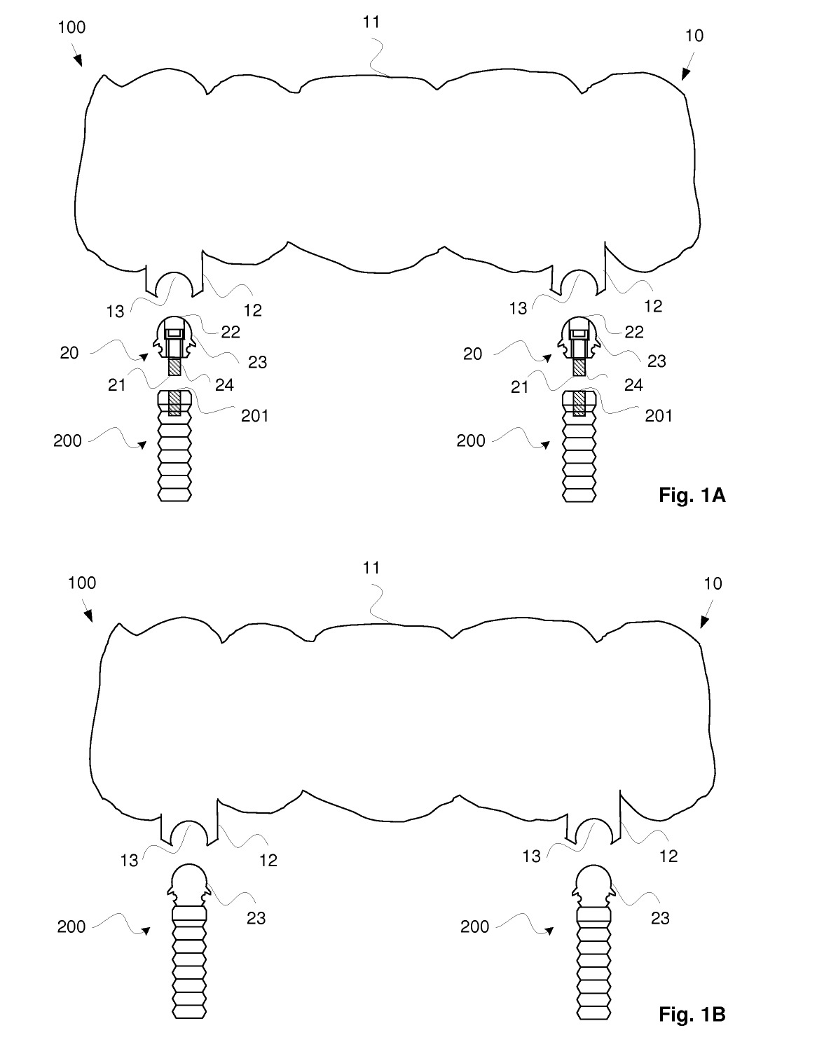

In one embodiment, according to FIG. 1, the male member 23 is of a rigid material, such as a material selected from the group comprising titanium, cobalt, chrome, or cobalt-chrome, while the female member 13 is of a compliant material, such as a thermoplastic material, such as an acrylate polymer or acetal polymer, such as a material selected from the group comprising PMMA and POM. The female member 13 is comprised as a monolithic part of the dental superstructure 10. Thus, the dental superstructure is monolithically shaped, to comprise the female members 13. This may be accomplished by transferring the position information with regard to the male members 23 in the oral cavity of the patient to a CAD/CAM system or a sintering system, whereafter the CAD/CAM system or the sintering system shapes the dental superstructure 10 from one single piece of metal through milling or through sintering the dental superstructure from a powder set, in known fashions. The powder set may however comprise different layers of powder fractions or powder sorts, to accomplish for example a dental superstructure 10 with a harder or softer proximal part and a harder or softer distal part, to tailor the physical characteristics after the intended situation.

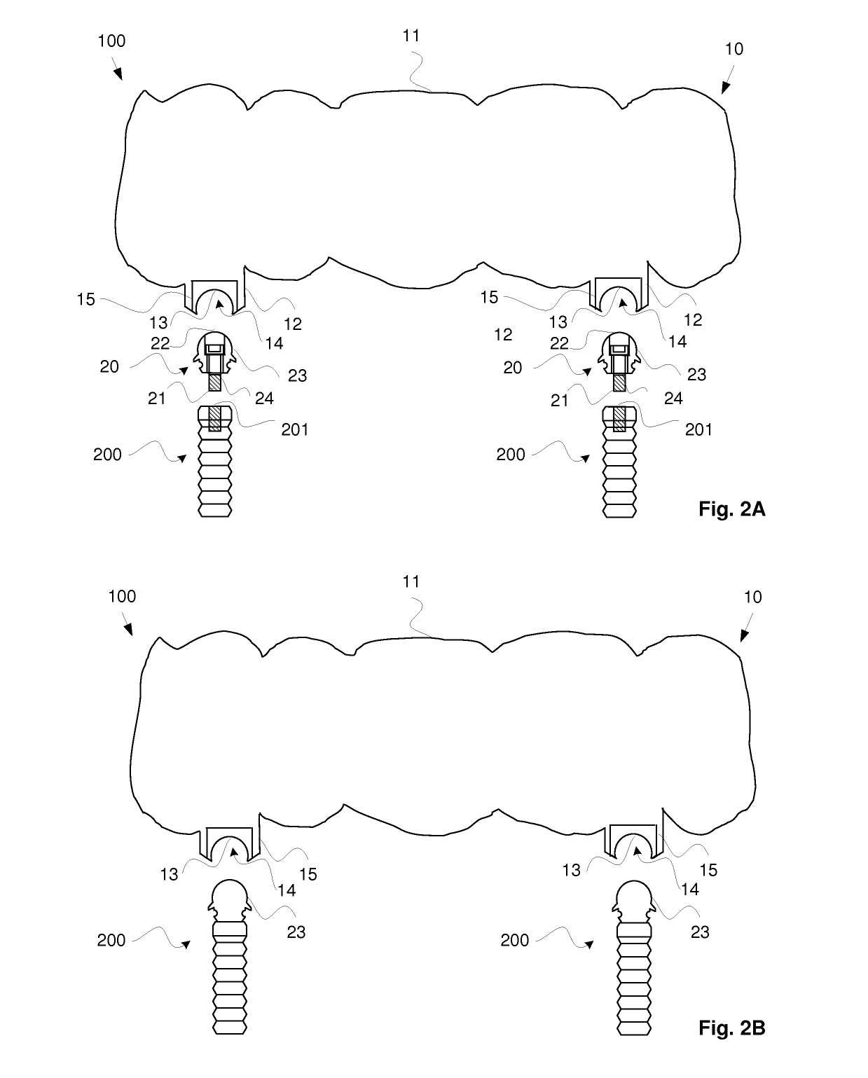

In another embodiment, according to FIG. 2, the male member 23 is also of a rigid material, such as a material selected from the group comprising titanium, cobalt, chrome, or cobalt-chrome, and the female member 13 is of a compliant material, such as a thermoplastic material, such as an acrylate polymer or acetal polymer, such as a material selected from the group comprising PMMA and POM. The female member 13 is however not comprised as a monolithic part of the dental superstructure 10, but instead positioned in a female member housing 14. The female member housing 14 then has an outer shape corresponding to housing cavities 15 in the main body 11. These cavities may be cylindrical or parallelepipedical, such as cubic. The outer shape of the female member housing 14 then has a shape corresponding to the shape of the housing cavity 15. The female housing 14 may then be fixed to the main body 11 through use of a suitable glue or cement. In this way, the main body 11 does not need to be of the same material as the female member 13, but can instead be made of a solid material, such as titanium, cobalt, chrome, or cobalt-chrome. Then, the main body may be manufactured in a separate process, such as a separate milling or sintering step, while the female housing may in turn also be separately manufactured in a separate milling or sintering step. In this way, it is possible to manufacture the main body 11 in a solid material, and pre-manufacture large blocks of compliant material, comprising several female members 13, which then are cut out of said large blocks into a shape that fits the housing cavities 15 formed in the main body 11 of the dental superstructure 10.

When manufacturing a superstructure 10 in this way, stereo-data in respect of a dental situation of a patient with osseointegrated dental implants 200 is first obtained. Then this information is provided to a software, wherein the information regarding dental situation together with information regarding male members 23 of a dental abutment 20, digitally or physically attached to said dental implant or being a monolithical part of said dental implant 200, is processed. The software may in this way adapt female members 13 in the 3D drawing, such that they correspond to the male members 23 actually present in the oral cavity of the patient.

Thus, when the entire superstructure is to be manufactured as a monolithic body of a compliant material, as in FIGS. 1a and 1b, the female members 13 may be arranged digitally in the software to match the location and position of the male members 23 in the oral cavity of the patient. However, if the superstructure is to be manufactured in a more solid material, such as a metal, in accordance with FIGS. 2a and 2b, the software may have digital cavities 15 to be positioned in the 3D drawing in correspondence with the positions and locations of the male members 23, such that a predefined block comprising the female member 13, such as a female member housing 14, in accordance with above, may be exactly fitted in said cavity 15. If the superstructure 10 is to be manufactured as a monolithic body of a rigid material, such as metal, and the male member 23 instead should be provided with a layer of a compliant material, to envision a snap fit between the male member 23 and the female member 13, this latter step is not necessary.

Subsequently, the 3D drawing is provided to a CAD/CAM mill or sintering equipment, wherein the dental superstructure 10 is shaped in accordance with the 3D drawing. The dental superstructure is shaped such that it comprises a main body 11 and at least two connecting parts 12 for connection to said dental abutment 20 and/or dental implant 200. This may, in accordance with above, result in a dental superstructure 10 as a monolithic body of a compliant material, including female members 13. However, it may also result in a superstructure 10 of a rigid material, such as metal, such as titanium, cobalt, chrome, or cobalt-chrome, as a monolithic body including female members 13. Additionally, also in accordance with above, it may result in a dental superstructure 10 of a rigid material, such as metal, such as titanium, cobalt, chrome, or cobalt-chrome, with cavities 15 shaped and sized to fittingly receive a block comprising the female member 13, such as a female member housing 14. The female member housing 14 may then be of a compliant material, and its outer contour, size and shape corresponds to the inner contour, size and shape of the cavity 15, which has been provided as a digital information in the software. The position of the female member 13 in the female member housing 14 is then precalculated to correspond to the position and orientation of the corresponding male member 23 in the oral cavity of the patient. The female member housing 14 may then be attached to the dental superstructure 10 by for example gluing.

Although the present invention has been described above with reference to specific embodiments, it is not intended to be limited to the specific form set forth herein. Rather, the invention is limited only by the accompanying claims and, other embodiments than the specific above are equally possible within the scope of these appended claims.

In the claims, the term “comprises/comprising” does not exclude the presence of other elements or steps. Furthermore, although individually listed, a plurality of means, elements or method steps may be implemented by e.g. a single unit or processor. Additionally, although individual features may be included in different claims, these may possibly advantageously be combined, and the inclusion in different claims does not imply that a combination of features is not feasible and/or advantageous. In addition, singular references do not exclude a plurality. The terms “a”, “an”, “first”, “second” etc do not preclude a plurality. Reference signs in the claims are provided merely as a clarifying example and shall not be construed as limiting the scope of the claims in any way.

1. A dental superstructure for attachment to dental abutments and/or a dental implants, said dental superstructure comprising:
a main body and a plurality of connecting parts for connection to said dental abutments and/or dental implants, said main body connecting said connecting parts;
said connecting parts comprising a female member for receiving a male member of a dental abutment or a dental implant, wherein said female member is of a compliant material.

2. The dental superstructure according to claim 1, wherein said female member is a monolithic part of the dental superstructure.

3. The dental superstructure according to claim 1, wherein said female member is comprised in a female member housing, which in turn is fixed to the main body.

4. The dental superstructure according to claim 3, wherein said female member housing is fitted in a housing cavity in the main body.

5. The dental superstructure according to claim 4, wherein the outer shape of the female member housing is cylindrical or parallelepipedic and that sad housing cavity has a corresponding shape.

6. The dental superstructure according to claim 5, wherein said main body is of a rigid material, such as titanium or cobalt-chrome.

7. The dental superstructure according to claim 1, wherein the female member is spherical.

8. The dental superstructure according to claim 1, wherein the female member comprises a thermoplastic polymer.

9. The dental superstructure according to claim 8, wherein the thermoplastic polymer is an acrylic polymer or an acetal polymer.

10. The dental superstructure according to claim 9, wherein the acrylic polymer or the acetal polymer is PMMA or POM, respectively.

11. A dental superstructure attaching system for attachment of a dental superstructure to at least one implant, said dental superstructure attaching system comprising:
a dental abutment comprising a proximal implant connecting part and a distal dental superstructure connecting part;
a dental superstructure comprising a main body and at least one connecting part for connection to said dental abutment;
wherein one or both of the distal dental superstructure connecting part and the connecting part of the dental superstructure are of a compliant material, such that said dental superstructure may be removably attached to said dental abutment through a snap fit connection between said distal dental superstructure connecting part and said connecting part of the dental superstructure.

12. The dental superstructure attaching system according to claim 11, wherein the dental superstructure is a dental superstructure.

13. The dental superstructure attaching system according to claim 11, wherein said distal dental superstructure connecting part is of a compliant material and the connecting part of the dental superstructure is of a rigid material.

14. The dental superstructure attaching system according to claim 13, wherein said rigid material is titanium or cobalt-chrome.

15. The dental superstructure attaching system according to claim 11, wherein the compliant material comprises a thermoplastic polymer.

16. The dental superstructure attaching system according to claim 15, wherein the thermoplastic polymer is an acrylic polymer or an acetal polymer.

17. The dental superstructure attaching system according to claim 16, wherein the acrylic polymer or the acetal polymer is PMMA or POM, respectively.

18. The dental superstructure attaching system according to claim 11, wherein said distal dental superstructure connecting part and said connecting part of the dental superstructure is male member and a female member, respectively.

19. The dental superstructure attaching system according to claim 18, wherein said male member comprises a spherical head and said female member is a spherical cavity, corresponding in shape and size to the spherical head of the male member, such that the spherical head may be snap fitted into the spherical cavity.

20. A method for manufacturing of a dental superstructure, comprising: obtaining stereo-data in respect of a dental situation of a patient with at least two osseointegrated dental implant,
applying information regarding a male member of a dental abutment, digitally or physically attached to said dental implant or being a monolithical part of said dental implant;
shaping said dental superstructure, such that said dental superstructure comprises a main body and at least two connecting parts for connection to said dental abutment and/or dental implant, said main body connecting said connecting parts, and said connecting parts comprising a female member for receiving said male member of the dental abutment or the dental implant, wherein said female member is shaped of a compliant material.

21. The method according to claim 20, wherein said shaping is performed through milling or sintering.

22. A method for manufacturing of a dental superstructure, comprising:
obtaining stereo-data in respect of a dental situation of a patient with at least two osseointegrated dental implant,
applying information regarding a male member of a dental abutment, digitally or physically attached to said dental implant or being a monolithical part of said dental implant;
shaping said dental superstructure in a metal, such that said dental superstructure comprises a main body with at least two predefined cavities
arranging a female member housing in each predefined at least two predefined cavities, such that connecting parts for connection to said dental abutment and/or dental implant are obtained, said main body connecting said connecting parts, and said connecting parts comprising a female member in said female member housing for receiving said male member of the dental abutment or the dental implant, wherein said female member is shaped of a compliant material.

23. The method according to claim 22, wherein said shaping is performed through milling or sintering.
